(19) United States
(12) Patent Application Publication
(10) Pub. No.: US 2005/0231845 A1
(43) Pub. Date: Oct. 20, 2005

(54) Recording medium, servo signal reproducing method, and servo signal recording method

(75) Inventor: Go Shirouzu, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/094,483

(22) Filed: Mar. 31, 2005

(30) Foreign Application Priority Data
Mar. 31, 2004 (JP) 2004-103692
Mar. 23, 2005 (JP) 2005-083908

(51) Int. Cl. G11B 5/09; G11B 19/02; G11B 5/584

(52) U.S. Cl. 360/48; 360/69; 360/77.12

(57) ABSTRACT

The present invention provides a recording medium where data cannot be unjustly accessed even if the recording medium is stolen because a data recording area for recording data is equipped and a servo signal for controlling an access of a data recording and/or reproducing mechanism to the data recording area is encoded with user's unique information and recorded; a method of reproducing the data from the recording medium; and a method of recording the servo signal in the recording medium.

### BACKGROUND OF THE INVENTION

1. Field of the Invention

The present invention relates to a recording medium where a security function is given, a servo signal reproducing method, and a servo signal recording method.

2. Description of the Related Art

These years are known various recoding media that can record data and reproduce the recorded data. In these recoding media a high recording density and high capacity in a data recording area rapidly progress as an information amount to be recorded augments, and furthermore, a new recording medium is being developed. Accompanying such the high recording density, a servo signal is recorded in order to control a tracking of a component, for example, a recording/reproducing component such as a head and a pickup, for accessing a data area provided in a recording medium and recording data, or for reproducing recorded data. For example, as a recording medium of computer data is known a two-reel cartridge or a single reel cartridge housing a magnetic tape, and in addition, a flexible disk or a hard disk. And as a recording medium of a large memory capacity is also known one where a servo signal is recorded so that a recording/reproducing mechanism can accurately trace a track in reproducing data (see the specification of U.S. Pat. No. 5,930,065). In addition, also in a hard disk a servo signal is recorded in order to control a tracking of a magnetic head. Furthermore, also in a holographic recording medium of a next generation is known one that provides an area for recording a servo signal at a place other than a data recording area.

In this connection, these days, in order to improve a security, it is requested for a recording medium to have functions of restricting no one but an authorized user to be able to use it and of preventing data tampering. In order to satisfy these requests is known a recording medium that restricts a recording on or a reproducing from (access to) the recording medium by performing an encryption by a password recorded on a semiconductor memory (cartridge memory: CM) within a cartridge (see Published Japanese Translation of PCT International Publication for Patent Application No. 2003-514295 (WO 01/35193: PCT/GB00/04266)).

In this connection, when if the access restriction described above is performed to data written on a recording medium, the medium itself is stolen, there is a possibility that there occurs a problem of such a security's being broken and the data being plagiarized by such a password leakage, a change to an unjust cartridge memory, an overwrite on control information restricting the access to the recording medium.

Consequently, it is strongly requested a recording medium whose data cannot be unjustly accessed; a method of the data's being able to be recorded and reproduced from the recording medium; and a method of recording a servo signal on the recording medium, even if the recording medium is stolen.

### SUMMARY OF THE INVENTION

A first invention in order to solve such the problems provides a recording medium that comprises a data recording area for recording data, and where a servo signal for controlling an access of a data recording and/or reproducing mechanism to the data recording area is encoded with user's unique information and is recorded.

In accordance with the recording medium, because the servo signal is encoded with the user's unique information, it becomes impossible to access data recorded on the recording medium by any of an unjust recording/reproducing apparatus and recording/reproducing method that cannot decode the servo signal; the data recorded on the recording medium is protected even if the recording medium is stolen. Particularly in a recent large capacity of a recording medium, it is effective because the servo signal is recorded by nothing but a dedicated servo writer and a user cannot change it.

In addition, a second invention provides a magnetic tape that comprises a support body and a magnetic recording layer formed on one face of the support body, and where a data band for recording data and a servo band, on which a servo signal for controlling a tracking of a recording/reproducing mechanism for recording/reproducing the data is recorded, are provided in the magnetic recording layer, wherein the servo signal is encoded with using user's unique information of a user scheduled to use the magnetic tape.

In accordance with the magnetic tape, because the servo signal is encoded with the user's unique information, it becomes impossible to access data recorded in a recording medium by an unjust recording/reproducing apparatus and recording/reproducing method that cannot decode the servo signal, and if the recording medium is stolen, the data recorded in the recording medium is protected. Particularly in a recent large-capacity recording medium, because a servo signal is recorded nothing but by a dedicated servo writer and a user cannot change the servo signal, it is effective.

In addition, a third invention provides a servo signal reproducing method that reproduces a servo signal recorded in a recording medium and comprises a step A1 of reading the servo signal encoded with user's unique information from the recording medium by a servo signal reproducing mechanism, and a step A2 of decoding the read servo signal with the user's unique information.

In accordance with the servo signal reproducing method, because appropriate servo information for controlling a tracking of the reproducing mechanism is obtained by reading the servo signal encoded with the user's unique information from the recording medium and decoding the read servo signal, nothing but a recording medium where a servo signal encoded with authentic user's unique information is written can be accessed.

In addition, a fourth invention provides a servo signal recording method that records a servo signal in a recording medium and comprises a step B1 of encoding the servo signal with user's unique information, and a step B2 of recording the encoded servo signal in the recording medium.

In accordance with the servo signal recording method, the servo signal is encoded with the user's unique information and is recorded in the recording medium, and thereby a recording medium can be manufactured that can be accessed nothing but by a recording/reproducing apparatus having authentic user's unique information.

### BRIEF DESCRIPTION OF THE DRAWINGS

FIG. 1 is a drawing showing servo bands and data bands provided on a magnetic tape.

FIG. 2A is a partial enlargement drawing of the magnetic tape shown in FIG. 1; FIG. 2B is a drawing showing a read pulse of a servo signal.

FIG. 3 is a schematic drawing showing an example of a structure of a servo pattern.

FIG. 4 is a drawing showing one example of a data structure embedded in a whole of a servo signal.

FIG. 5 is a drawing showing one example of a data structure embedded in a whole of a servo signal.

FIG. 6 is a drawing showing a part of a cartridge of a magnetic tape by cutting it away.

FIG. 7 is a drawing showing a configuration of a servo writer.

FIG. 8 is a drawing illustrating a method of writing a servo signal.

FIG. 9 is a drawing showing another example of a servo pattern.

### DESCRIPTION OF THE PREFERRED EMBODIMENTS

Here will be described a recording medium, a servo signal reproducing method, and a servo signal recording method of the present invention in detail.

In the present invention a “recording medium” means a medium designed to comprise a base body and a recording area provided on the base body, to cause a temporary or permanent change such as any of physical and chemical changes in the recording area, to thereby record a predetermined data signal, to drive the recording medium or a reproducing component (head, pickup), to access data recorded in a required recording area, to detect the change, and to be able to reproduce the data. As a concrete example of the recording medium can be cited a magnetic recording medium, an optical recording medium, a magneto-optical recording medium, and the like.

A magnetic recording medium uses a magnetic head as a reproducing component; in recording data, records a data signal as a magnetic change in a data recording area; and in reproducing data, detects the data signal recorded as the magnetic change in the data recording area by a magnetic head and reproduces the data. As the magnetic head can be cited an MR (Magneto Resistive) head, a GMR (Giant Magneto Resistive) head, and the like. As a concrete example of the magnetic recording medium can be cited a flexible disk, a magnetic tape, a hard disk, and the like. In the magnetic recording medium a servo signal is recorded in a servo signal recording area provided in an area different from the data recording area. For example, in a magnetic tape a servo signal is magnetically recorded on a servo band provided thereon by a servo signal recording magnetic head, is read from the servo band by a magnetic head, and is reproduced.

An optical recording medium uses an optical pickup as a reproducing component; in recording data, records a data signal as any of physical and chemical changes in a data recording area; in reproducing data, detects the data signal recorded in the data recording area as any of the physical and chemical changes due to light by the optical pickup; and reproduces the data. As an concrete example of the optical recording medium can be cited a CD-ROM, CD−R, CD+R, DVD−R, DVD+R, blue ray disc, HDDVD, a recording disk utilizing any of a holographic and a two-photon absorption, and the like. In the optical recording medium a servo signal is recorded in a servo signal area provided in an area different from the data recording.

As a magneto-optical recording medium can be cited, for example, a mini disk (MD), CD−RW, CD+RW, DVD−RW, DVD+RW, and the like.

Then in a recording medium of the present invention a data recording area for recording data is equipped, a servo signal for controlling an access to the data recording area of a mechanism for recording and/or reproducing data is encoded with user's unique information, and is recorded in a servo signal recording area provided in an area different from the data recording area.

The servo signal is encoded with user's unique information of a user scheduled to use a recording medium. The encode of the servo signal is not specifically limited and can be performed by a known method. For example, a method of using an exclusive OR, and an encryption method such as a public key encryption system and a private key encryption system are applicable. When it is necessary to keep an especially high security, a public key encryption system such as an RSA (Rivest Shamir Adleman system and an MH (Merkle-Hellman system) are preferable. When using the public key encryption system such as the RSA and the MH, it is preferable to separate user's unique information into a private key UID1 and a public key UID2 and to perform an encryption based on any of the keys.

When using an exclusive OR in encoding the servo signal, it can be coded, for example, by the exclusive OR of information containing manufacturer information and servo area information with user's unique information.

In addition, a method of reproducing a servo signal from a recording medium where a servo signal thus encoded comprises a step A1 of reading the servo signal encoded with user's unique information from the recording medium by a servo signal reproducing mechanism, and a step A2 of decoding the read servo signal with the user's unique information. Here a servo signal is one for controlling a tracking of a reproducing mechanism for reproducing data.

The step A1 is performed by a servo signal reproducing mechanism used depending on each recording medium. For example, in a magnetic recording medium the step A1 can be performed by a magnetic head; in an optical recording medium by an optical pickup.

The step A2 is performed by any of hardware and software. The hardware can be configured of an electrical circuit provided at a servo reader. Depending on a kind of the recording medium, the servo reader is preferable to comprises a plurality of electrical circuits that can decode an encoded servo signal recorded in the recording medium. And the servo reader is preferable to have a selector for selecting the plurality of the electrical circuits, depending on a kind of the recording medium. Thus by one reader it is enabled to select the electrical circuits as needed, depending on an encoding method of a recorded servo signal, a kind of a recording medium, and the like and to appropriately decode the servo signal.

In addition, a method of recording a servo signal encoded in the recording medium comprises a step B1 of encoding the servo signal with user's unique information, and a step B2 of recording the encoded servo signal in the recording medium.

The step B1 can be performed by any of hardware and software. The hardware can be configured of an electrical circuit provided at a servo writer. For example, depending on a kind of the recording medium, the servo writer is preferable to comprise a plurality of electrical circuits that can encode a servo signal recorded in the recording medium. And the servo writer is preferable to have a selector for selecting the plurality of the electrical circuits, depending on a kind of the recording medium. Thus by one writer it is enabled to select the electrical circuits as needed, depending on an encoding method of a recorded servo signal, a kind of a recording medium, and the like and to appropriately encode the servo signal.

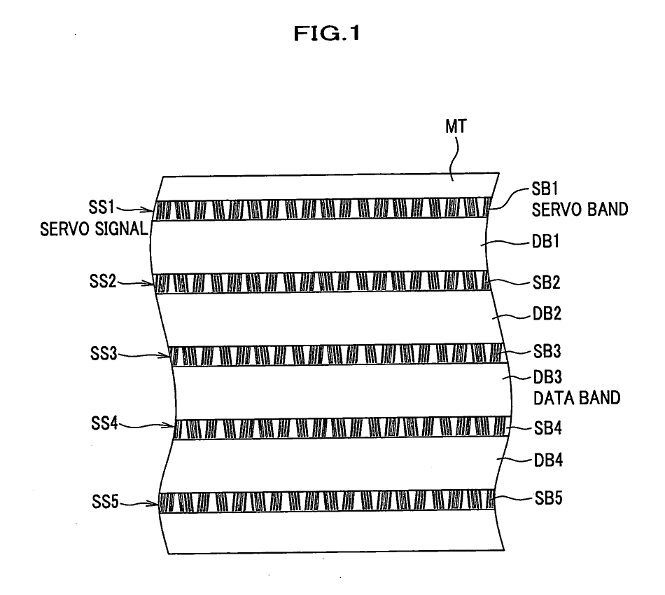

Here will be described an embodiment of the present invention, referring to drawings as needed. This embodiment will describe a recording medium related to the first present invention, taking a magnetic tape MT as an example thereof. The magnetic tape MT comprises a magnetic layer formed by a magnetic material being coated on one face of a support body, and as shown in FIG. 1, the magnetic layer comprises a plurality of servo bands SB1, SB2, SB3, SB4, and SB5 extending in longitudinal directions of the tape; and data bands DB1, DB2, DB3, and DB4 positioned between respective servo bands SB1, SB2, SB3, SB4, and SB5.

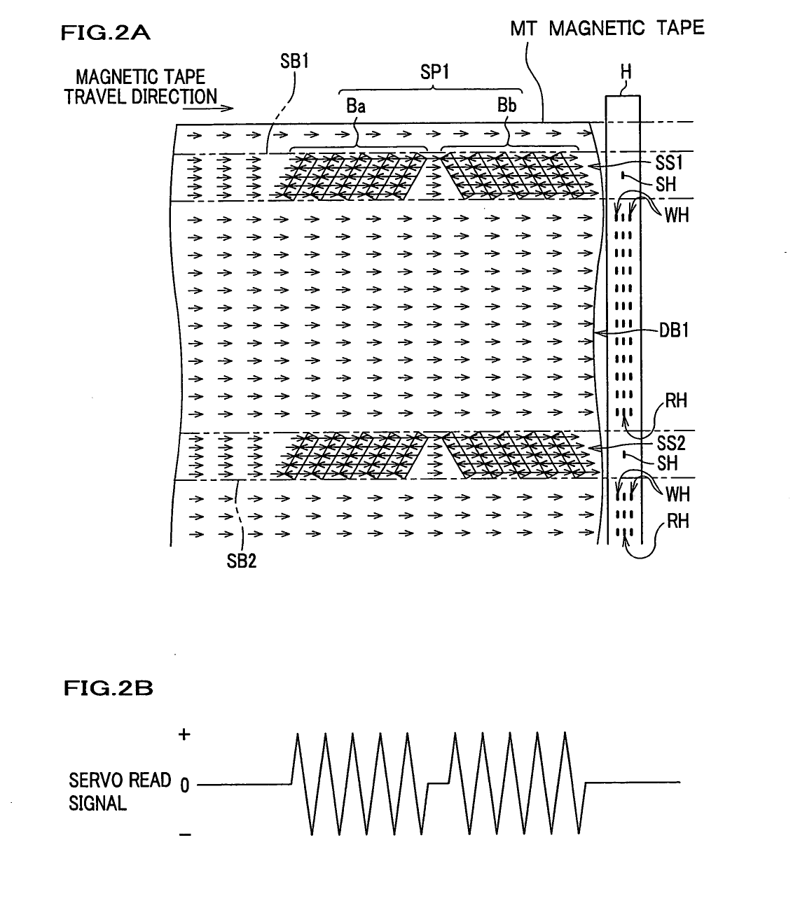

As shown in FIG. 2A, each of the servo bands SB1, SB2, SB3, SB4, and SB5 is magnetized in a travel direction (see an arrow mark in FIG. 2: hereinafter in the embodiment the direction is referred to as “forward direction” as needed) out of the longitudinal directions of the magnetic tape MT. In a partial enlargement drawing shown in FIG. 2A, small arrow marks show magnetization directions. And magnetizing the servo bands SB1, SB2, SB3, SB4, and SB5 in a reverse direction, servo signals SS1, SS2, SS3, SS4, and SS5 are written (see FIG. 1). The servo signal SS1 (SS2, SS3, SS4, and SS5) forms one servo pattern SP1 (SP2, SP3, SP4, and SP5) of a burst Ba of a portion magnetized like five stripes making a positive slant angle for the travel direction (carried direction) of the magnetic tape MT and a burst Bb of a portion magnetized like five stripes, through an interval, making a negative slant angle for the travel direction (carried direction) of the magnetic tape MT; the servo pattern SP1 (SP2, SP3, SP4, and SP5) is repeatedly formed in the longitudinal directions at a predetermined distance, and thus the servo signals SS1, SS2, SS3, SS4, and SS5 are configured (see FIG. 1).

And the data bands DB1, DB2, DB3, and DB4 between the respective servo bands SB1, SB2, SB3, SB4, and SB5 are also uniformly magnetized in the forward direction. Of course, the magnetic tape MT shown in FIG. 1 and 2A is a tape where data is not recorded; and when the data is recorded, portions magnetized in any of the forward direction and the reverse direction are formed according to data contents of the data bands DB1, DB2, DB3, and DB4.

Meanwhile, although the embodiment configures the servo pattern SP1 (SP2, SP3, SP4, and SP5) of every five stripes slanted positively and the other every five negatively, for example, it is appropriately changeable so as to configure the servo pattern SP1 of every two stripes slanted positively and the other every two negatively; to alternately form one five stripes slanted positively and the other five negatively, and one four stripes slanted positively and the other four negatively; and the like. In addition, in FIGS. 1 and 2A, in order to be easily understood, the servo pattern SP1 (SP2, SP3, SP4, and SP5) is drawn comparatively large.

In addition, in FIG. 2A is shown a positional relationship of a magnetic head H for the magnetic tape MT. In the magnetic head H servo read elements SH for reading the servo signal SS1 (SS2, SS3, SS4, and SS5) are provided side by side in a lateral direction (hereinafter simply referred to as “lateral direction”) at a distance same as that of a plurality of the servo bands SB1, SB2, SB3, SB4, and SB5. And between each of the servo read elements SH are provide a plurality of recording elements WH side by side in two lines in the lateral direction of the magnetic tape MT. Furthermore, between the recording elements WH are provided a plurality of reproducing elements RH side by side in a line in the lateral direction of the magnetic tape MT.

For the magnetic tape MT thus described, when recording or reproducing data by the magnetic head H of a magnetic tape drive, the servo signal SS1 (SS1, SS2, SS3, SS4, and SS5) is read by the servo read elements SH. Because the servo pattern SP1 (SP2, SP3, SP4, and SP5) of the servo signal SS1 (SS1, SS2, SS3, SS4, and SS5) slants for the travel direction (longitudinal direction) of the magnetic tape MT and is formed with each non-parallel stripe, a timing of the servo read elements' SH reading the servo signal SS1 (SS1, SS2, SS3, SS4, and SS5) and detecting a pulse thereof differs in a relative position between the magnetic tape MT and the magnetic head H in the lateral direction. Therefore, by controlling a position of the magnetic head H so that a timing for reading the pulse becomes a predetermined condition, it is enabled to accurately position any of the recording elements WH and the reproducing elements RH at a predetermined track of the data bands DB.

At this time an output (peak voltage value) where the servo read elements SH read the servo signal SS1 (SS1, SS2, SS3, SS4, and SS5) depends on any of a variation rate and amount of a change between a portion where a signal is recorded and another portion where the signal is not recorded. And in the embodiment a magnetic direction largely varies from the forward direction to the reverse direction at the change portion of the servo pattern SP1 (SP2, SP3, SP4, and SP5) magnetized in the reverse direction from a portion of the servo band SB1 (SB2, SB3, SB4, and SB5) of a base magnetized in the forward direction. In addition, the magnetic direction also largely varies from the reverse direction to the forward direction at the change portion from the portion of the servo pattern SP1 (SP2, SP3, SP4, and SP5) magnetized in the reverse direction to the portion of the servo band SB1 (SB2, SB3, SB4, and SB5) of the base magnetized in the forward direction. Therefore, depending on the large magnetic variation, as shown in FIG. 2B, the servo signal can be read in a large output. Accordingly, an S/N ratio (signal to noise ratio) of a read signal of the servo signal SS1 (SS1, SS2, SS3, SS4, and SS5) can be improved.

The magnetic tape MT thus configured can be especially effectively used, when it is used for any of a magnetic tape with a thinner magnetic layer and a magnetic tape drive having a narrower width of the servo read elements SH for reading the servo signal SS1 (SS1, SS2, SS3, SS4, and SS5) due to a narrower width of a data track. In other words, although because conventionally a care has to be taken of a saturation phenomenon of an MR (Magneto Resistive) element, it is avoided to magnetize a servo signal in a reverse direction and to write the servo signal at a portion magnetized by a direct current, the configuration shown in FIG. 2A that can make the read output of the servo signal becomes preferable when making the magnetic layer thinner and the width of the data track narrower in order to enlarge a memory capacity per volume.

As the magnetic tape MT, an MrT (product of a magnetic layer residual magnetization Mr and a thickness T of a magnetic layer) is preferablely 5.0×10⁻¹⁰ T·m (4.0×10⁻² memu/cm²) to 7.5×10⁻⁸ T·m (6.0 memu/cm²); more preferably 5.0×10⁻¹⁰ T·m (4.0×10⁻² memu/cm²) to 5.0×10⁻⁸ T·m (4.0 memu/cm²); and most preferably 5.0×10⁻¹⁰ T·m (4.0×10⁻² memu/cm²) to 2.5×10⁻⁸ T·m (2.0 memu/cm²). If the MrT is within the ranges, the MR element of the head can be prevented from being saturated, and thus the noise can be reduced.

In addition, a Tw (track width of servo read elements) is preferably 0:1 μm to 30 μm, more preferably 0.1 μm to 15 μm, and most preferably 0.1 μm to 7 μm.

Furthermore, the thickness of the magnetic layer is preferably 10 nm to 300 nm, more preferably 10 nm to 200 nm, and most preferably 10 nm to 100 nm.

Describing preferable examples of the magnetic tape MT in more detail, one is preferable that has a non-magnetic layer and a magnetic layer on one face of a support body and a back layer on the opposite face thereof. In addition, the magnetic tape MT may have layers other than the non-magnetic layer, the magnetic layer, and the back layer. For example, the magnetic tape MT may have a soft magnetic layer containing soft magnetic powders, a second magnetic layer, a cushion layer, an overcoat layer, an adhesion layer, and a protection layer. These layers can be provided at adequate positions so as to effectively bring out their functions. A thickness of the non magnetic layer can be made 0.5 μm to 3 μm: the thickness of the non magnetic layer is desirable to be thicker than that of the magnetic layer.

Although a ferromagnetic powder for use in the magnetic layer of the magnetic tape MT is not specifically limited, a ferromagnetic metal powder and a hexagonal ferrite powder are preferable.

An average particle size of the ferromagnetic powder is preferably 20 nm to 60 nm. When the ferromagnetic powder used is acicular and the like, an average long axis length is preferably 30 nm to 100 nm, more preferably 35 nm to 90 nm, and most preferably 40 nm to 80 nm. By making the average long axis length not more than 100 nm, the noise cab be reduced and a preferable S/N ratio of a servo signal can be obtained. In addition, making the average long axis length not less than 30 nm, a preferable coercivity Hc can be ensured. An average acicular ratio of a ferromagnetic powder particle is preferably 3 to 10; more preferably 3 to 8, and most preferably 4 to 8. When the ferromagnetic powder is platy, the average particle size is represented by an average plate diameter and is preferably 25 nm to 35 nm; and an average plate ratio is preferably 2 to 5.

In the ferromagnetic metal powder, an SBET (specific surface area by the BET (Brunauer, Emmett and Teller) method) is usually 40 m²/g to 80 m²/g and preferably 50 m²/g to 70 m²/g. A crystal size is usually 10 nm to 25 nm and preferably 11 nm to 22 nm. A pH of the ferromagnetic metal powder is preferably not less than 7. As concrete examples of the ferromagnetic metal powders, a single metal and alloy of Fe, Ni, Fe—Co, Fe—Ni, Co—Ni, Co—Ni—Fe, and the like are cited, and within a range of not more than 20 mass percent of metal compositions can be contained aluminum, silicon, sulfur, scandium, titan, vanadium, chromium, manganese, copper, zinc, yttrium, molybdenum, rhodium, palladium, gold, tin, antimony, boron, barium, tantalum, tungsten, renium, silver, lead, phosphorus, lanthanum, cerium, praseodymium, neodymium, tellurium, bismuth, and the like. In addition, the ferromagnetic metal powders may also contain a small amount of water, a hydroxide, and an oxide.

These ferromagnetic metal powders can be manufactured according to a known method. Although there is specifically no limitation for shapes of the ferromagnetic metal powders, usually an acicular shape, a grit shape, a cubic shape, a rice grain shape, a plate shape, and the like are used. It is specifically preferable to use acicular ferromagnetic metal powders.

The coercivity Hc of the ferromagnetic metal powders is preferably 144 kA/m to 300 kA/m and more preferably 160 kA/m to 224 kA/m. In addition, a saturation magnetization thereof is preferably 85 A·m²/kg to 150 A·m²/kg and more preferably 100 A·m²/kg to 130 A·m²/kg.

In addition, as the hexagonal ferrite powders there are a barium ferrite, a strontium ferrite, a lead ferrite, a calcium ferrite, and various substitution materials, for example, a Co substitution material, and the like. To be more precise, as the hexagonal ferrite powders are cited a magnetoplumbite type barium ferrite and strontium ferrite, the magnetoplumbite type ferrite whose particle surface is covered with spinel, further a compound magnetoplumbite type barium ferrite and strontium ferrite that partially contain a spinel phase, and the like; and other than predetermined elements, following ones may be contained: Al, Si, S, Nb, Ti, V, Cr, Cu, Y, Mo, Rh, Pd, Ag, Sn, Sb, Te, W, Re, Au, Bi, La, Ce, Pr, Nd, P, Co, Mn, Zn, Ni, B, Ge, and the like. Generally, the hexagonal ferrite powder where following compounds are added can be used: Co—Zn, Co—Ti, Co—Ti—Zr, Co—Ti—Zn, Ni—Ti—Zn, Nb—Zn—Co, Sn—Zn—Co, Sn—Co—Ti, Nb—Zn, and the like. Some hexagonal ferrite powders contain a specific impurity in accordance with materials and/or manufacturing methods. The hexagonal ferrite powders are a hexagonal plate shape.

When reproducing with a MR head to particularly raise a track density, a noise can be reduced and a preferable S/N ratio can be obtained by making an average plate diameter of the hexagonal ferrite powders used not more than 50 nm. In addition, by making the average plate diameter not less than 15 nm, a preferable coercivity Hc can be ensured. The specific surface area by the BET method is usually 30 m²/g to 200 m²/g and preferably 50 m²/g to 100 m²/g. The specific surface area roughly checks with an arithmetic calculation value from a powder diameter and thickness thereof.

The narrower a distribution of the plate diameter and the thickness, the more preferable it is. Although many distributions are not a normal distribution, they are expressed as σ/(average plate diameter or average thickness)=0.1 to 0.5 if calculated and expressed in a standard deviation for a powder size. In order to make a powder size distribution sharp, it is performed to make a powder generation-reaction system uniform as much as possible and to also dispense a distribution improvement treatment to a generation powder. For example, such a method of selectively dissolving an ultra fine powder in an acid solution is also known. In a vitrification-crystallization method a more uniform powder is obtained by performing heat treatments plural times and separating a nucleus generation and growth. Although the corercivity Hc measured in a magnetic powder can be made till around 40 kA/m to 400 kA/m, 144 kA/m to 300 kA/m is preferable. Although a higher Hc is more advantageous in a high density recording, it is limited according to an ability of a recording head. An Hc can be controlled by the powder size (a plate diameter and a plate thickness), kinds and amounts of contained elements, substitution sites of elements, powder generation-reaction conditions, and the like.

A saturation magnetization σₛ is preferably 30 A·m²/kg to 70 A·m²/kg. The finer a powder becomes, the smaller the σₛ tends to become. With respect to manufacturing methods thereof, there are a method of lessening any of a crystallization temperature and heat treatment time, another method of increasing addition compounds, still another method of increasing an amount of a surface treatment, and the like. In addition, it is possible to also use a W type hexagonal ferrite.

As manufacturing methods can be cited (1) a vitrification-crystallization method of mixing metal oxides, which substitutes such a boron oxide as a glass forming material for a barium carbonate, an iron oxide, and an iron so as to become a desired ferrite composition, then melting it, making an amorphous material by rapid cooling, next dispensing a reheating treatment, and then cleaning and pulverizing it, and thereby obtaining a barium ferrite crystalline powder; (2) a water-heat reaction method of neutralizing a metal salt solution of a barium ferrite composition with alkali, removing byproducts, then heating it in a liquid phase at not less than 100 degrees Celsius, and then cleaning and pulverizing it, and thereby obtaining the barium ferrite crystalline powder; and (3) a coprecipitation method of neutralizing the metal salt solution of the barium ferrite composition with alkali, removing byproducts, then drying it, performing a heat treatment at not more than 1100 degrees Celsius, and pulverizing it, and thereby obtaining the barium ferrite crystalline powder.

In dispersing a magnetic material a surface of a magnetic powder is also treated with a finishing agent appropriately selected according to a dispersion medium and a polymer. The finishing agent may be any of an inorganic compound and an organic compound. As main compounds typical examples are: an oxide and hydroxide of Si, Al, P, and the like; various silane coupling agents; and various titan coupling agents. An amount thereof is around 0.1 to 10 mass percent for the magnetic material. A pH thereof is also important for dispersion: it is usually around 4 to 12, and although there is an optimum value thereof in accordance with the dispersion medium and the polymer, around 6 to 11 is selected from a chemical stability and storage stability of a recording medium. A water content contained in the magnetic material also influences the dispersion. Although there is an optimum value in accordance with the dispersion medium and the polymer, it is usually around 0.1 to 2.0 mass percent.

Next will be described the servo patterns SP1, SP2, SP3, SP4, and SP5 (hereinafter typically referred to as “servo pattern SP” in some case).

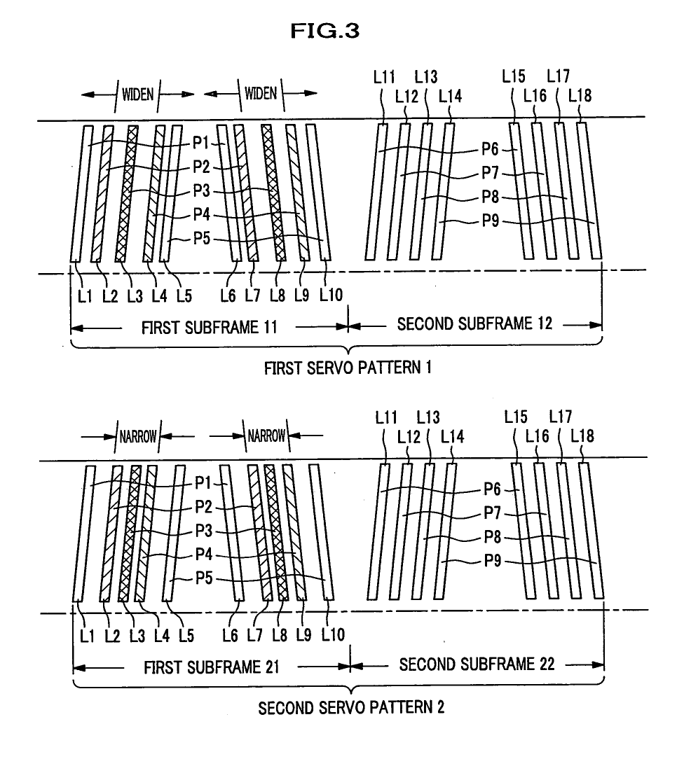

As shown in FIG. 3, the servo pattern SP is configured of two kinds of a first servo pattern 1 and a second servo pattern 2 arbitrary plurally provided along tape longitudinal directions. And the first servo pattern 1 comprises a first subframe 11 and second subframe 12 of non-parallel stripes; the second servo pattern 2 also comprises a first subframe 21 and second subframe 22 of non-parallel stripes.

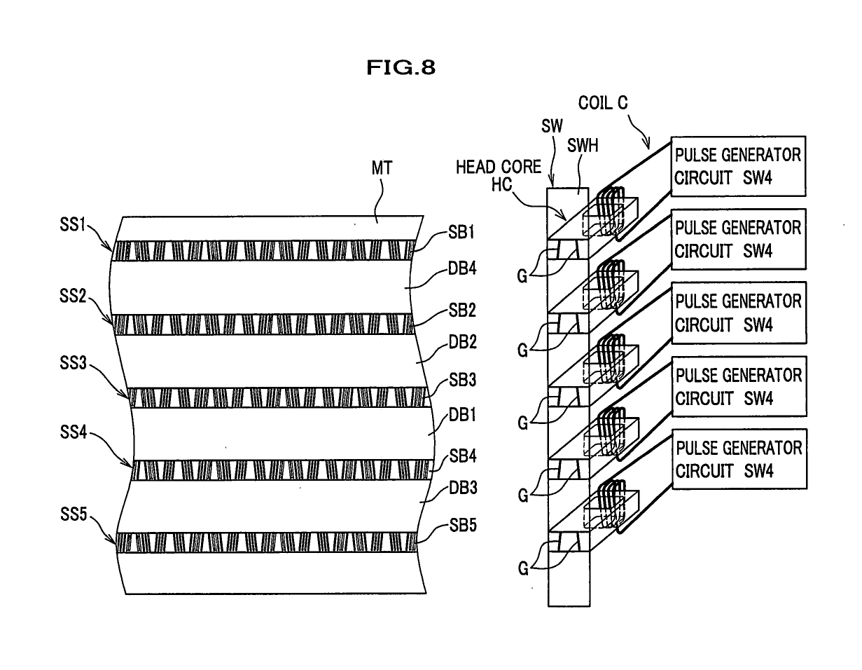

The first subframes 11 and 21 are formed like a non-parallel bottom-open-reverse V letter by five linear patterns L1 to L5 obliquely formed for the tape longitudinal directions and five linear patterns L6 to L10 symmetrically formed for the patterns L1 to L5. In this connection, these linear patterns L1 to L10 are formed with gap patterns G (see FIG. 8) like a bottom-open-reverse V letter described later, and thereby each distance of linear patterns (L1, L6), (L2, L7), (L3, L8), (L4, L9), and (L5, L10), which become a pair of the bottom-open-reverse V letters in order from left, is designed to be same as each distance of the gap patterns G. Meanwhile, hereinafter for convenience of a description, the linear patterns (L1, L6) to (L5, L10) of the pairs of the bottom-open-reverse V letters are assumed to be called a first bottom-open-reverse V letter pattern P1, a second bottom-open-reverse V letter pattern P2, a third bottom-open-reverse V letter pattern P3, a fourth bottom-open-reverse V letter pattern P4, and a fifth bottom-open-reverse V letter pattern P5 in order from left of FIG. 3.

In the first subframe 11 of the first servo pattern 1, the second bottom-open-reverse V letter pattern P2 and the fourth bottom-open-reverse V letter pattern P4 are formed so as to draw away from the third bottom-open-reverse V letter pattern P3. In addition, in the first subframe 21 of the second servo pattern 2, the second bottom-open-reverse V letter pattern P2 and the fourth bottom-open-reverse V letter pattern P4 are formed so as to near the third bottom-open-reverse V letter pattern P3. Meanwhile, the second subframes 12 and 22 are configured of four linear patterns L11 to L14 obliquely formed for the tape longitudinal directions and four linear patterns L15 to L18 symmetrically formed for the patterns L1 to L14, and each of bottom-open-reverse V letter patterns P6 to P9 configured of the linear patterns L11 to L18 is provide at a same distance in the tape longitudinal directions. Meanwhile, in the linear patterns non-parallel ones may be designed to be a set.

Thus differently forming the first subframes 11 and 21 of the first servo pattern 1 and the second servo pattern 2, respectively, thereby data showing 37 1” results in being embedded in the first servo pattern 1, and data showing “0” in the second servo pattern 2. And these first servo pattern 1 and second servo pattern 2 are arbitrary provided in the tape longitudinal directions, and thereby it is designed to be able to read predetermined data, for example, when reading a whole of one servo signal SS1.

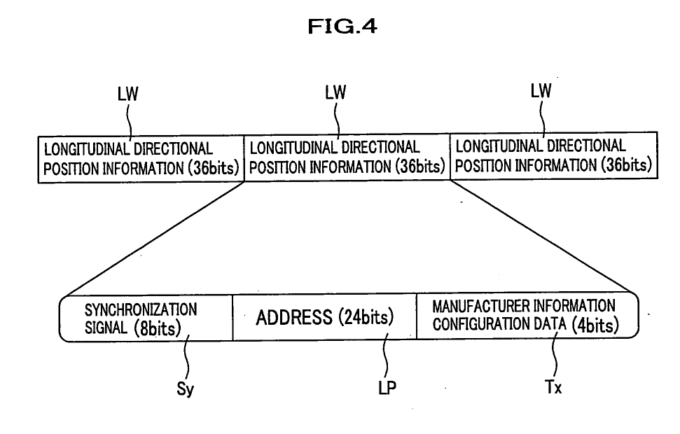

Next will be described a data structure based on “Standard ECMA-319” as one example of a data structure embedded in the whole of servo signals SS1, referring to FIG. 4. This is a data structure encoded based on a user's unique information UID described later. Meanwhile, because servo signals SS2 to SS5 are designed to be the data structure substantially similar to the servo signal SS1, a description thereof is omitted.

As shown in FIG. 4, data embedded in a whole of servo signal SS1 is configured of 36-piece servo patterns, plural pieces of longitudinal directional position information (LPOS WORD) LW of 36-bit data. The longitudinal directional position information LW comprises an 8-bit synchronization signal (Sync Mark) Sy showing a head thereof, an address (Longitudinal Position) LP configured of 6 pieces of 4-bit data showing a position in tape longitudinal directions, and manufacturer information configuration data (Manufacturer Data) Tx of 4-bits.

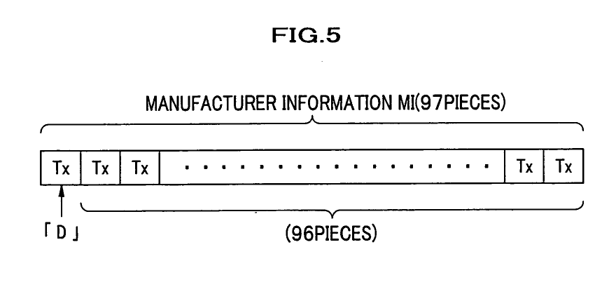

As shown in FIG. 5, the manufacturer information configuration data Tx is data recognized as one piece of manufacturer information MI by reading 97 pieces of the longitudinal directional position information LW: in a configuration thereof data (for example, data “D” expressed by “0001” of 4-bit data being converted in a predetermined table) showing a head is written at the head of the manufacturer information configuration data Tx; and thereafter data (for example, 0, 1, . . . , 9, A , B, C”) other than the “D” is arbitrary written in the 96 pieces of the manufacturer information configuration data Tx. And in the 96 pieces of the manufacturer information configuration data Tx result in being embedded data showing a manufacturer ID, tape manufactured day information, a tape serial number, a servo writer ID, an operator ID, and the like; and servo band information showing any one of five servo bands SB1 to SB5.

The longitudinal directional position information LW thus described is encoded, based on the user's unique information UID of a user who schedules a use of the magnetic tape MT, and is recorded in the servo signal SS1. For example, assuming the user's unique information UID to be n bits, the user's unique information UID may be recorded as a servo signal where a logical operation result by an exclusive logical sum of the longitudinal directional position information LW and user's unique information UID of every n bits is encoded. The operation is performed by an encode mechanism in a servo writer described later. In addition, an encoding method is not limited to the exclusive logical sum, encryption methods such as a public key encryption system and a private key encryption system are applicable. When it is necessary to keep an especially high security, public key encryption systems such as the RSA (Rivest Shamir Adleman) system and the MH (Merkle-Hellman) system are preferable: in that case it is necessary to separate the user's unique information UID into a private key UID1 and a public key UID2 and to perform an encryption, based on any of the keys.

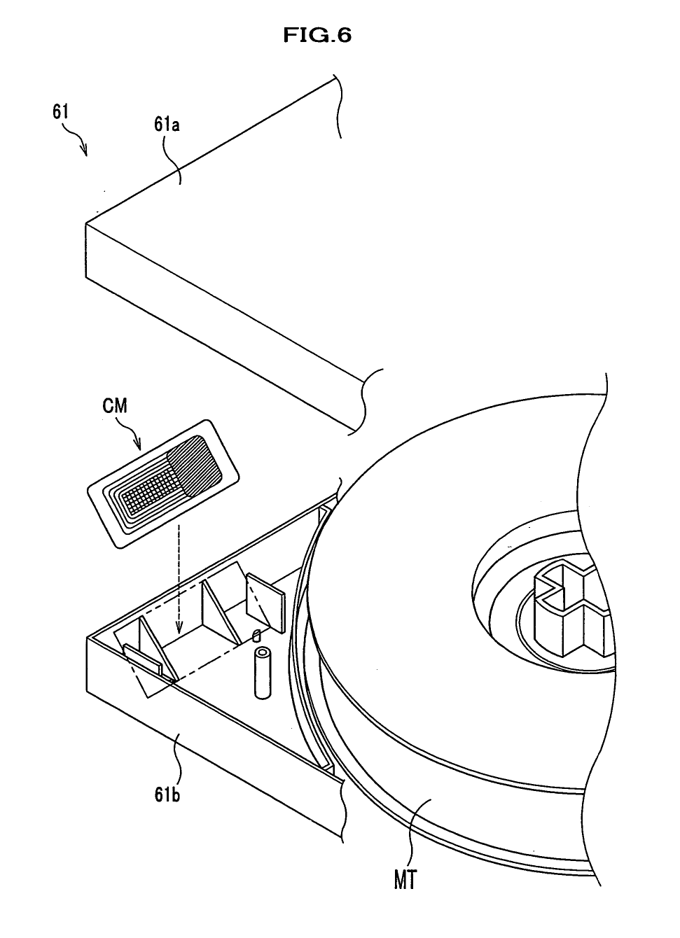

In addition, as shown in FIG. 6, a cartridge 61 for accommodating the magnetic tape MT comprises an upper housing 61a and a lower housing 61b, and a CM (Cartridge Memory) is desirable to be provided at a side corner of the lower housing 61b. The CM is an RFID (Radio Frequency Identification) IC tag configured of an EEPROM (Electrically Erasable Programmable Read-only Memory), a control IC, and a radio communication antenna and can communicate with a reader/writer outside the cartridge by any of a magnetic field and an electromagnetic wave. Particularly, the RFID IC tag uses any electric wave of 13.56 MHz, 135 kHz, 2.45 GHz, and a UHF band, communicates with the reader/writer outside the cartridge by radio, writes/reads/rewrites information, and further receives electric power. In the EEPROM are recorded manufacturing information of the cartridge and data control information of the magnetic tape MT. In the control information is included information that can recognize the presence/absence of an encode of a servo signal, and an area thereof is preferably a ROM area where an overwrite cannot be done. Thus in a recording/reproducing operation described later, because the presence/absence of the encode can be determined before the magnetic tape MT being loaded in a recording/reproducing apparatus, there is an advantage that a processing becomes rapid.

Next will be described an operation for a drive's (recording/reproducing apparatus') accessing the magnetic tape MT.

When a cartridge where the magnetic tape MT is accommodated is inserted, the drive draws out the magnetic tape MT from the cartridge and winds it on a machine reel. While the servo read elements SH of the magnetic head H on a tape path between the cartridge and the machine reel slides in contact, the elements SH read a servo signal recorded on the magnetic tape MT.

Meanwhile, when the cartridge is inserted in the drive, a reader/writer of a CM provided within the drive accesses the CM within the cartridge and recognizes the presence and absence of an encode of the servo signal. If it is determined that the servo signal is not encoded, the drive does not execute a decode processing based on the user's unique information UID as a usual operation mode and reads the longitudinal directional position information LW as it is. On the other hand, if determined that the servo signal is encoded, the drive reads the longitudinal directional position information LW as a security operation mode via the decode processing based on the user's unique information UID. The decode processing is executed by a decode mechanism and can be executed by a same kind of a processing as an encode mechanism mounted on a servo writer described later. Meanwhile, when a public key encryption system is used as an encoding method, a decode is executed by the private key UID1.

And based on a pulse distance read from the servo signal and the longitudinal directional position information LW decoded, in the magnetic head H a tracking thereof is adjusted by a known tacking mechanism. At this time, if the drive does not adequately decode the longitudinal directional position information LW, the drive determines that a magnetic tape in the cartridge is not the magnetic tape MT having an authentic servo signal and ejects the cartridge. In addition, a drive not having the decode mechanism cannot naturally execute a tracking for the magnetic tape MT, whose servo signal is encoded with the user's unique information UID, and cannot access data on the magnetic tape MT. If the servo signal is not normally encoded, the cartridge is similarly ejected. Thus the magnetic tape MT encoded can be accessed by nothing but a drive having the authentic user's unique information UID.

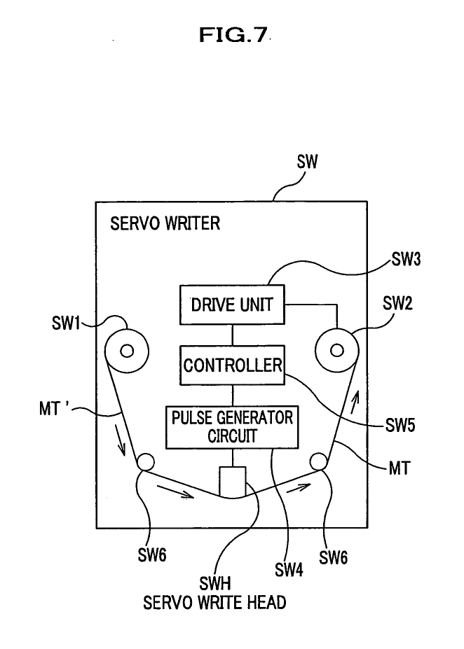

Next will be described a servo writer SW for writing the servo signals SS1 to SS5 in the magnetic tape MT, referring to FIGS. 7 and 8.

As shown in FIG. 7, the servo writer SW mainly comprises a supply reel SW1, a winder SW2, a drive unit SW3, a pulse generator circuit SW4, a servo write head SWH, and a controller SW5. In addition, the servo writer SW also comprises a power source unit, a cleaner for cleaning the magnetic tape MT, a verifier for verifying the servo signals SS1 to SS5 written, and the like not shown.

On the supply reel SW1, in a large diameter winding of a pancake, is set a magnetic tape MT′ slit into a product width from a web raw material of a wide width before the servo signals SS1 to SS5 are written; and the supply reel SW1 sends out the magnetic tape MT′ in writing the servo signals SS1 to SS5. The magnetic tape MT′ sent out by the supply reel SW1 is guided by a guide SW6 and the like and is carried to the servo write head SWH. And the magnetic tape MT where the servo signals SS1 to SS5 are written with the servo write head SWH is carried to the winder SW2 by being guided with another guide SW6 and the like. The winder SW2 is rotated by the drive unit SW3 and winds the magnetic tape MT where the servo signals SS1 to SS5 are written.

The drive unit SW3 is a unit for rotating the winder SW2 and comprises a motor not shown, a motor drive circuit for supplying a motor current, a gear for coupling a motor shaft and the winder SW2, and the like. The drive unit SW3 generates the motor current in the motor drive circuit, based on a motor current signal from the controller SW5, supplies the motor current to the motor, furthermore transmits rotation drive force of the motor through the gear, and thereby rotates the winder SW2.

The pulse generator circuit SW4 is a circuit for supplying a recording current pulse to a plurality of coils C (see FIG. 8) provided at the servo write head SWH, based on a pulse control signal from the controller SW5, and is independently provided at each of the plurality of the coils C. To be more precise, the pulse generator circuit SW4 alternately generates a plus pulse current and zero current having any of a plus polarity and a minus polarity, based on the pulse control signal from the controller SW5, and thereby writes the first servo pattern 1 and the second servo pattern 2 at a predetermined position of each of the servo bands SB1 to SB5. Meanwhile, the recording current pulse is a sufficient current value to magnetize a magnetic layer of the magnetic tape MT′ by a leakage magnetic flux from the head gap patterns G (see FIG. 8) and is set by taking such characteristics of the coils C (see FIG. 8) of the servo write head SWH into consideration.

As shown in FIG. 8, the servo write head SWH has the non-parallel gap patterns G, G, . . . like a bottom-open-reverse V letter formed at a position corresponding to each of the servo bands SB1 to SB5 and records the servo signals SS1 to SS5 with the gap patterns G, respectively.

Meanwhile, in each of the gap patterns G provided at a same distance in the tape lateral directions, although a position of the tape lateral directions has to be strictly specified, that of the tape longitudinal directions need not be strictly specified and may be displaced from other gap patterns G to some extent. It is because in the embodiment the servo band SB1 can be identified by referring to nothing but one servo signal SS1 even if each of the servo signals SS1 to SS5 is displaced and formed with the gap patterns G thus displaced each other in the tape longitudinal directions. Thus it is not necessary to accurately form a gap that is offset in the servo write head SWH, and thereby cost-cutting can be realized in a manufacturing thereof.

In addition, head cores HC are independent for the gap patterns G, respectively, and on these head cores HC the coils C are wound, respectively. And each of the pulse generator circuits SW4 connected to each of the coils C converts data for distinguishing individual servo bands SB1 to SB5 processed by the controller SW5 (see FIG. 7) to a recording current pattern and supplies the recording current pattern to the coil C.

The controller SW5 comprises an encode mechanism for encoding the longitudinal directional position information LW, based on the user's unique information UID. The encode mechanism may be a hardware processing by an electric circuit and may be a software processing by a microprocessor. Generally, because a servo writer performs a recording for a wide variety of magnetic tapes, it is preferable that the circuit is assembled for each user's unique information UID and that the servo writer comprises a mechanism for selecting a dedicated communication circuit, depending on a magnetic tape wanted to be recorded, when the encode mechanism is the hardware processing. On the other hand, when the encode mechanism is the software processing, it is preferable that plural pieces of user's unique information UID is memorized in a memory not shown and that the servo writer comprises a mechanism for culling (selecting) a desired user's unique information UID by the microprocessor, depending on the magnetic tape.

As described before, to the encode mechanism based on the user's unique information UID is applied any of a public key encryption system and a private key encryption system in addition to a logical operation. Accordingly, the magnetic tape MT having an encoded servo signal can be accessed by nothing but a drive having a decode mechanism for decoding the servo signal based on an authentic user's unique information UID.

Meanwhile, a timing of a recording current supplied to each of the head cores HC from each electric circuit may be set in any way. For example, although when supplying the recording current in synchronization with each of the pulse generator circuits SW4 to each of the head cores HC, a positional relationship in the tape longitudinal directions of each of the servo signals SS1 to SS5 is ruled by a positional relationship in the tape longitudinal directions of each of the gap patterns G, there is no problem because of the reason described above, even if each of the servo signals SS1 to SS5 is displaced and formed in the tape longitudinal directions. On the other hand, although when supplying the recording current not in synchronization with each of the pulse generator circuits SW4 to each of the head cores HC, in some case each of the servo signals SS1 to SS5 is displaced and formed in the tape longitudinal directions because of an occurrence of a random phase difference for a recording current pattern: also in this case there is no problem because of the reason.

A verifier determines whether or not a servo signal is accurately recorded, and to the verifier can be applied an equivalent of the magnetic head H described in the drive. It goes without saying that the verifier naturally comprises a decode mechanism for reading a servo signal recorded and decoding it based on the user's unique information UID. In this case the decode mechanism may be designed to comprise the controller SW5 and simplify the circuit.

Thus following effects can be obtained in the embodiment:

The magnetic tape MT where a servo signal is encoded, based on the user's unique information UID, thereby the servo signal can be encoded with nothing but a drive having an authentic user's unique information UID, and the data is not accessed even if the cartridge is stolen. In addition, with respect to a conventional servo writer without functions of encoding and decoding based on a user's unique information UID, a security can be simply improved by nothing but adding an encode mechanism and a decode mechanism. In many cases it suffices only to rewrite firmware of a program of a portion for controlling an operation of the servo writer and the drive, and it is not necessary to add a large amount of cost.

In this connection, the present invention is embodied in various modes without being limited to the embodiment.

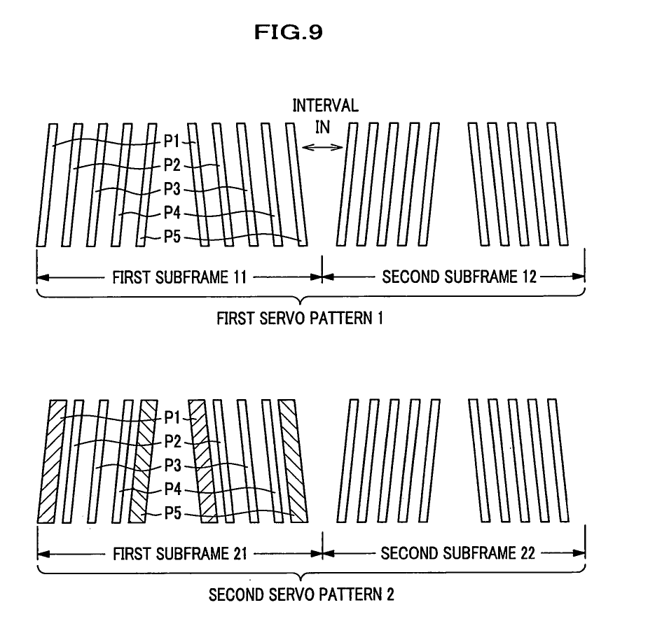

In the embodiment, although distances of the five bottom-open-reverse V letter patterns P1 to P5 are changed and thereby two kinds of the servo patterns 1 and 2 are formed, the present invention is not limited thereto. For example, as shown in FIG. 9, form the first servo pattern 1 so that the distances of the bottom-open-reverse V letter patterns P1 to P5 in the first subframe 11 become a same distance. In addition, form the second servo pattern 2 so that widths (lengths in the tape longitudinal directions) of the first bottom-open-reverse V letter pattern P1 and fifth bottom-open-reverse V letter pattern P5 in the first subframe 21 become larger. Thus formed, because two kinds of servo patterns can be made, servo band information can be embedded in the servo signals SS1 to SS5 same as in the embodiment.

Meanwhile, it can be simply performed to thus change a width of a bottom-open-reverse V letter pattern by increasing/decreasing time for flowing a recording current. In addition, a size of the width can be arbitrary set, and the widths of the first bottom-open-reverse V letter pattern P1 and fifth bottom-open-reverse V letter pattern P5 may also be set narrower than a usual width.

In addition, the two kinds of servo patterns may be formed by changing an interval IN between the burst Ba and burst Bb of the servo signals SS1 to SS5.

In addition, although in the embodiment servo read elements are provided, the present invention is not limited thereto: at least one servo head is sufficient and a quantity thereof may be set any. In addition, although one is sufficient for each of a servo band identification unit and a decryption unit, a quantity thereof may be same as that of the servo read elements. The data structures shown in FIGS. 4 and 5 are also one example and are not limited thereto. For example, nothing but servo band information may be embedded in a servo signal without embedding the LPOS, manufacturer information, and the like.

In addition, the recording medium of the present invention is not limited to a tape, the invention may be applied to a flexible disk and a hard disk. Furthermore, the recording system thereof may also be any of an optical recording and a magneto-optical recording, and a shaping by a magnetic printing and a stamper. And depending on a mode of the recording medium, a recording/reproducing method, a shaping method, and the like, information recorded on the recording medium can be appropriately selected. For example, when the recording medium is the disk, track address information is used as the longitudinal directional position information LW. The track address information is preferably a gray code whose adjacent address is different by only one bit. Naturally, even if the track address information is encoded, based on the user's unique information UID, it is preferably the gray code: as such an encoding method is cited a method of circular bit shifting. For example, if the user's unique information UID is 3 (decimal number), circularly shifting track address information 00110010 to left (or right) by three bits, thereby encode it to a value of 10010001 (or 01000110). As a bit number to be shifted may be directly used the user's unique information UID or else a value obtained by making one-direction hash function operate on the user's unique information UID.

1. A recording medium comprising:
a data recoding area for recording data,
wherein a servo signal for controlling an access of a data recording and/or reproducing mechanism to said data recording area is encoded with user's unique information and is recorded.

2. A recording medium according to claim 1, wherein said encoded servo signal is recorded in a servo signal recording area provided in an area different from said data recording area.

3. A recording medium according to claim 1, wherein said servo signal is encoded with user's unique information of a user scheduled to use a recording medium.

4. A recording medium according to claim 1, wherein said encoded servo signal is encoded with an exclusive OR, a public key system, and a private key system, using said user's unique information.

5. A magnetic tape comprising:
a support body; and
a magnetic recording layer formed on one face of said support body,
wherein a data band for recording data and a servo band, on which a servo signal for controlling a tracking of a recording/reproducing mechanism for recording/reproducing said data is recorded, are provided in said magnetic recording layer, and
wherein said servo signal is encoded with using user's unique information of a user scheduled to use the magnetic tape.

6. A magnetic tape according to claim 5, wherein said encoded servo signal is a logical operation result by an exclusive OR of longitudinal directional position information with said user's unique information.

7. A magnetic tape according to claim 5, wherein said encoded servo signal is encoded with any of a public key system and a private key system, using said user's unique information.

8. A magnetic tape according to claim 5, wherein a memory element is provided within a housing configuring a cartridge for housing said magnetic tape, and wherein control information that can recognize a presence or absence of an encode of said servo signal is recorded in the memory element.

9. A magnetic tape according to claim 8, wherein said memory element is an IC tag.

10. A magnetic tape according to claim 5, wherein said control information is recorded on said servo band magnetized in a forward direction in advance by a servo pattern being magnetized and formed in a reverse direction.

11. A magnetic tape according to claim 5, wherein a thickness of said magnetic recording layer is 10 to 300 nm.

12. A servo signal reproducing method for reproducing a servo signal recorded in a recording medium, the method comprising:
a step A1 of reading said servo signal encoded with user's unique information from said recording medium by a servo signal reproducing mechanism; and
a step A2 of decoding the read servo signal with said user's unique information.

13. A servo signal reproducing method according to claim 12, wherein said servo signal is one for controlling a tracking of a reproducing mechanism for reproducing data.

14. A servo signal reproducing method according to claim 12, wherein said servo signal is encoded with user's unique information of a user scheduled to use a recording medium.

15. A servo signal reproducing method according to claim 12, wherein said servo signal is encoded with any of an exclusive OR, a public key system, and a private key system, using said user's unique information.

16. A servo signal reproducing method according to claim 12, wherein said step A2 is performed by hardware.

17. A servo signal reproducing method according to claim 16, wherein said hardware is an electrical circuit provided at a servo reader, and said servo reader comprises a plurality of electrical circuits that can decode an encoded servo signal recorded in said recording medium, depending on a kind of the recording medium.

18. A servo signal reproducing method according to claim 17, wherein said servo reader comprises a selector for selecting said plurality of electrical circuits, depending on a kind of said recording medium.

19. A servo signal reproducing method according to claim 12, wherein said step A2 is performed by software.

20. A servo signal recording method for recording a servo signal in a recording medium, the method comprising:
a step B1 of encoding said servo signal with user's unique information; and
a step B2 of recording the encoded servo signal in said recording medium.

21. A servo signal recording method according to claim 20, wherein said servo signal is one for controlling a tracking of a reproducing mechanism for reproducing data.

22. A servo signal recording method according to claim 20, wherein said servo signal is encoded with user's unique information of a user scheduled to use a recording medium.

23. A servo signal recording method according to claim 20, wherein said servo signal is encoded with any of an exclusive OR, a public key system, and a private key system, using said user's unique information.

24. A servo signal recording method according to claim 20, wherein said step B1 is performed by hardware.

25. A servo signal recording method according to claim 24, wherein said hardware is an electrical circuit provided at a servo writer and said servo writer comprises a plurality of electrical circuits that can encode a servo signal recorded in said recording medium, depending on a kind of the recording medium.

26. A servo signal recording method according to claim 25, wherein said servo writer comprises a selector for selecting said plurality of electrical circuits, depending on a kind of said recording medium.

27. A servo signal recording method according to claim 20, wherein said step B1 is performed by software.
